(19) United States
(12) Patent Application Publication
(10) Pub. No.: US 2012/0253496 A1
(43) Pub. Date: Oct. 4, 2012

(54) AUTOMATED ADJUSTMENT FOR PRODUCING ROLLS OF MATERIAL IN AN INDUSTRIAL PROCESS

(75) Inventor: MACIEJ J. MALCZEWSKI, Pointe Claire (CA)

(73) Assignee: ABB INC., Cary, NC (US)

(21) Appl. No.: 13/075,375

(22) Filed: Mar. 30, 2011

(51) Int. Cl. G06F 19/00

(52) U.S. Cl. 700/103

(57) ABSTRACT

Systems and other embodiments for altering a primary roll are described. A system can comprise a calculation component configured to proactively find a caliper for material of a primary roll based, at least in part, on a desired caliper for a material of a secondary roll. The secondary roll can be produced from the primary roll. The system can also comprise a controller configured to proactively cause the material of the primary roll to implement with the caliper in response to finding the caliper for the material of the primary roll.

### TECHNICAL FIELD

The following generally relates to producing rolls of material in an industrial process and more particularly to automatically determining and employing operating parameters for producing a primary roll of the material used to produce a secondary roll of the material so that the secondary roll of the material includes desired physical features.

### BACKGROUND

An industrial process, such as making rolls of paper, may include creating an initial (primary) roll of paper, from raw materials, that is used to make a refined (secondary) roll of paper for an end user in accordance with end user specifications. The initial roll of paper includes paper having certain physical qualities such a caliper (thickness), moisture, and others. To make a roll of paper for an end user, the initial roll of paper is fed through another part of the industrial system to form the secondary roll of paper. This part of the system refines the paper in accordance with the end user's specifications. For example the paper can be subjected to the controlled stretch and pressure by different mechanical arrangements to reach the end users specification. Although the refined paper of the secondary roll can have different qualities than the paper of the primary roll, the qualities of the paper of the secondary roll are influenced by the qualities of the paper of the primary roll.

If the refined paper of the secondary roll does not have qualities that satisfy the end user's specifications, then certain operating parameters of the industrial process can be adjusted so that the refined paper satisfies the end user's specifications. For example, if the refined paper is thicker than the specified thickness, then the operator overseeing the industrial process can attempt to compute a thickness value for the primary roll of paper that will result in a desired thickness for the refined paper that satisfies the end user's specifications. The operator then manually tweaks, e.g., via entering data in a displayed graphical user interface or other tool, the system parameters used to generate the primary roll of paper, and operates the system to produce a subsequent secondary roll of paper based on the tweaked parameters. This tweaking of the operating parameters continues in a trial-and-error manner until the refined paper is produced with the end user specified thickness. Unfortunately, such an approach can be tedious and is susceptible to human error.

### SUMMARY

Aspects of the present application address these matters, and others.

According to one aspect, a method of an industrial process that produces a primary roll of material and a secondary roll of the material comprises identifying a physical characteristic set of a material of a first secondary roll of the material, where the material of the first secondary roll is produced from a material of a first primary roll and where the first primary roll is produced with a first property set. The method also comprises determining if the physical characteristic set of the material of the first secondary roll meets a predefined criteria set. The method further comprises identifying, in response to determining that the physical characteristic set of the material of the first secondary roll does not meet the predefined criteria set, a second property set for a second primary roll, where the second property set and the first property set are different and where the second property set causes a physical characteristic set of a material of a second secondary roll to meet the predefined criteria. The method additionally comprises causing without user interaction, the second primary roll to be proactively created with the second property set.

According to another aspect, a system includes a caliper determination component configured to proactively identify a caliper for material of a primary roll based, at least in part, on a desired caliper for a material of a secondary roll, where the secondary roll is produced from the primary roll. The system also includes a controller configured to proactively cause the material of the primary roll to be produced with the caliper in response to identifying the caliper for the material of the primary roll.

According to yet another aspect, a system includes an observation component configured to monitor a property set of a material of a secondary roll from an industrial process to produce a monitoring result, where the property set of the material of the secondary roll includes caliper of the material of the secondary roll. The system also includes a resolution component configured to make a determination on if the property set of the material of the secondary roll meets a criteria set based, at least in part, on the monitoring result. The system further includes a classification component configured to identify, in response to the determination being that the property set of the material of the secondary roll does not meet the criteria set, a change for a property set of a material of the primary roll of the industrial process, where the material of the primary roll supplies the material of the secondary roll. The system additionally includes a modification component configured to proactively alter the property set of the material of the primary roll with the change.

Those skilled in the art will appreciate still other aspects of the present application upon reading and understanding the attached figures and description.

### FIGURES

The present application is illustrated by way of example and not limitation in the figures of the accompanying drawings, in which like references indicate similar elements and in which:

FIG. 1 illustrates one embodiment of an industrial process that produces a secondary roll from material of a primary roll;

FIG. 2 illustrates one embodiment of an apparatus that can be used in the industrial process illustrated in FIG. 1;

FIG. 3 illustrates one embodiment of an apparatus that can be used in the industrial process illustrated in FIG. 1;

FIG. 4 illustrates one embodiment of a method for creating a secondary roll of material matching a criteria set without user interaction;

FIG. 5 illustrates one embodiment of a method for producing a secondary roll of material; and

FIG. 6 illustrates one embodiment of a method for obtaining caliper control for a secondary roll of material.

### DESCRIPTION

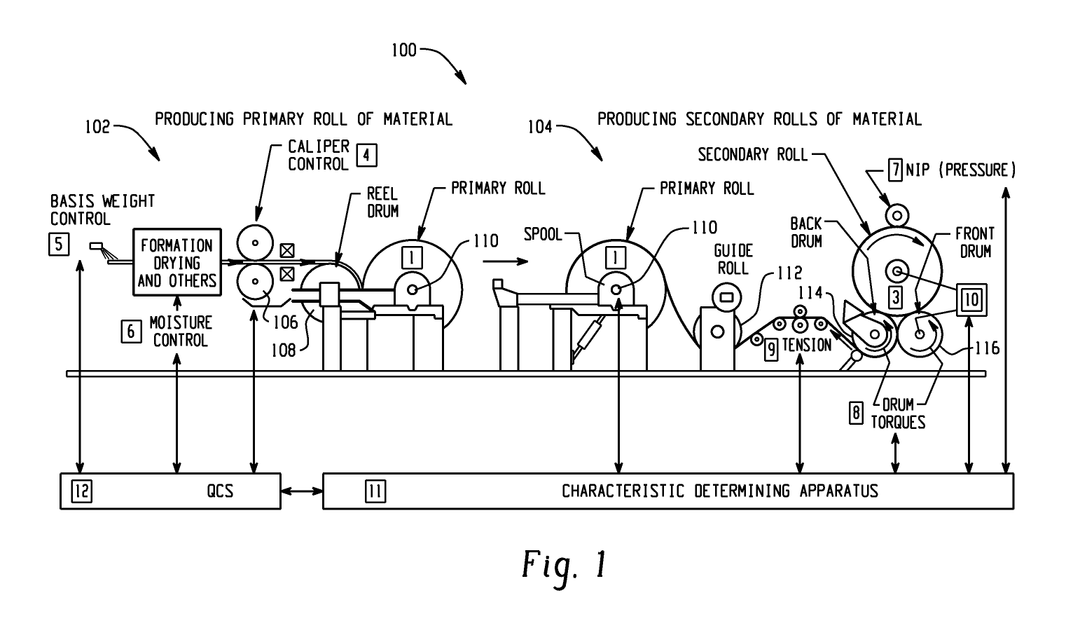

FIG. 1 illustrates an example system 100 for producing rolls of material. For explanatory purposes and sake of brevity, the following will be discussed in connection with producing rolls of paper. However, the following also applies to producing rolls of other materials such as plastic, steel, copper, and/or other materials. The system 100 shows a first part 102 where a general primary roll 1 of paper is produced and a second part 104 where a secondary roll 3 of paper refined to satisfy end user specification is produced from the primary roll 1 of paper.

Initially referring to the first part 102, the system 100 includes a basis weight control 5 which is used to influence paper compressibility. The system 100 further includes a moisture control 6 which is used to control moisture content via formation drying and other functions. The system 100 also includes a caliper control 4 which includes a one or more pairs of rollers 106, each pair being separated by a gap, through which a newly created paper material passes through. These rollers 106 can be hard or soft rollers. Individual rollers of the pair 106 are separated such that the paper material entering the rollers 106 exits the rollers 106 having an average thickness within a predetermined tolerance about a predetermined thickness. The caliper control 4, the basis weight control 5, and the moisture control 6 together are used in producing paper, in accordance with one or more predetermined physical characteristics, which subsequently passes through a reel drum 108 and is formed around a spool 110 to form the primary roll 1.

The illustrated embodiment shows the primary roll 1 transferring from the first part 102 onto a spool 110 of the second part 104. However, it is to be appreciated by one of ordinary skill in the art that the first part 102 and second part 104 can directly connect, be located in one room, be located in different parts of a building or complex, be located remote from one another, etc.

Turning to the second part 104, the primary roll 1 is attached to the spool 110. The paper of the primary roll 1 is the processed through a guide roll 112, drums (e.g., front 114 and back 116) and is wound around the core 10 to form a secondary roll 3, with tension 9 and drum torques 8, and a nip 7. The tension 9, drum torque 8, and nip 7 can influence the caliper of the refined paper of the secondary roll 3. For example, if the tension 9, drum torque 8, and nip 7 are all relatively high, then more pressure is exerted on the paper, which causes the paper to have a smaller caliper. This processing causes the paper from the primary roll 1 to become more refined and to have specific characteristics in accordance with an end user's criteria set of specifications. The refined paper with the specific characteristics forms the secondary roll 3.

In one instance, the physical characteristics of the refined paper of the secondary roll 3 may not meet a desired criteria set. For example, a caliper of the refined paper of the secondary roll 3 may not be within a specified thickness (i.e., not thick enough or too thick). In order to change the caliper of the refined paper of the secondary roll 3, the operating parameters for determining the caliper of the primary roll 1 can be changed since the refined paper of the secondary roll 3 is produced from the paper of the primary roll 1. As described in greater detail herein, as opposed to a person determining and effectuating this change, the change can occur automatically by the system, which may mitigate human error and increase throughput.

A characteristic determining apparatus 11 can determine what characteristics the paper of the primary roll 1 should have such that the refined paper meets the desired criteria set. The apparatus 11 and/or a quality control system (QCS) 12 can proactively make alterations (e.g., to the caliper control 4, basis weight control 5, and/or moisture control 6) to the first part of the system 102 so the refined paper of the secondary roll 3 meets the criteria set. Continuing with the thickness example above, alteration of the operating parameters for producing a primary roll 1 of paper can occur such that a caliper of the paper of the primary roll 1 is changed, and modification of the paper of the primary roll 1 can cause physical properties of the refined paper of the secondary roll 3 to change to satisfy the thickness criteria.

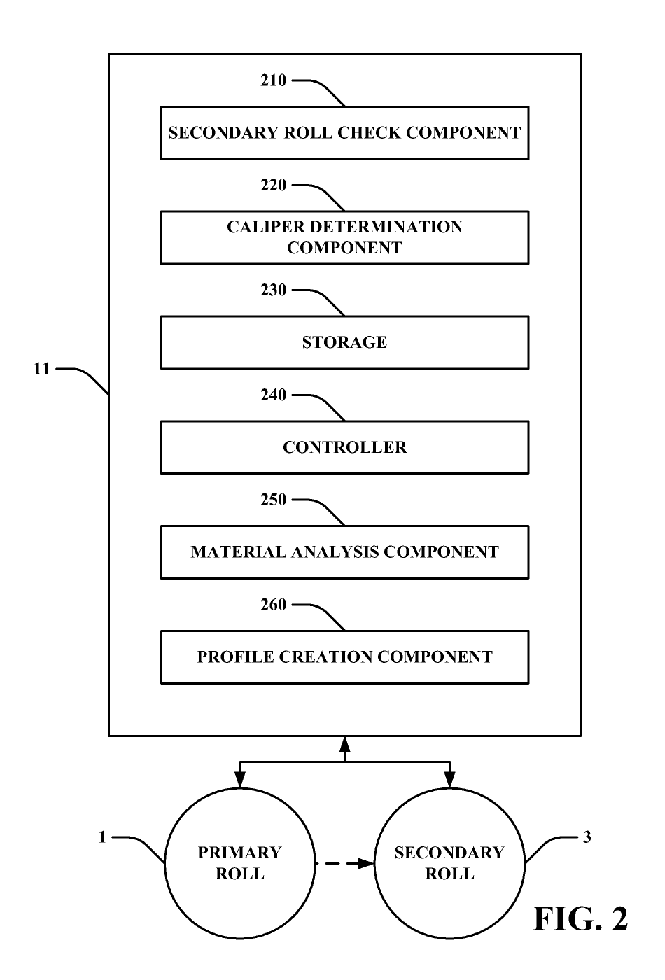

FIG. 2 illustrates one embodiment of the characteristic determining apparatus 11 shown in the system 100 of FIG. 1. While specific components and a controller are shown in this embodiment of the characteristic determining apparatus 11, it is to be appreciated that the characteristic determining apparatus 11 can be implemented with less components, more components, some of the components, without the controller, and others.

A secondary roll check component 210 is configured to make a determination on if the refined paper of the secondary roll 3 is being produced with the desired caliper. If the refined paper of the secondary roll 3 is being produced with the desired caliper, then the secondary roll check component 210 can continue checking the secondary roll in case a change in the caliper occurs.

However, if the refined paper of the secondary roll 3 is not being produced with the desired caliper, then the secondary roll check component can send an instruction to a caliper determination component 220 which invokes or triggers the caliper determination component to begin operation. The caliper determination component 220 is configured to identify (e.g., determine, find in a database, etc.) a caliper for the paper of the primary roll 1. This identification is based, at least in part, on a desired caliper for the refined paper of a secondary roll as the refined paper of the secondary roll 3 is made from the raw paper of the primary roll 1.

The caliper determination component 220 can identify the caliper for the paper of the primary roll 1 in various manners. In one embodiment, the caliper determination component 220 accesses storage 230 that includes a mapping (e.g., a look-up table) that maps primary roll paper characteristics mapped to secondary roll paper characteristics. The storage 230 can be a database structure, be separate from the characteristic determining apparatus 11, be remote from the system 100, and others. The storage 230 can include a plurality of database entries. A database entry may include information on what caliper value for the paper of the primary roll 1 results in refined paper of the secondary roll 3 having a particular caliper value. For example, an entry may indicate that a paper caliper of 83 μm produces a refined paper caliper within a predetermined tolerance about 80 μm.

Once the caliper for the paper of the primary roll 1 is identified by the caliper determination component 220, a controller 240 is configured to proactively (e.g., automatically, without human intervention) cause the paper of the primary roll 1 to be produced with the identified caliper. In one embodiment, the controller 240 controls or causes the quality control system 12 to make appropriate changes to the basis weight control 5, moisture control 6, and/or caliper control 4. For example, the controller can send an electronic signal to the quality control system 12 instructing the quality control system 12 on how to modify the basis weight control 5, moisture control 6, and/or caliper control 4 such that the paper of the primary roll 1 has the identified caliper.

As discussed above, the caliper determination component 220 can rely on storage 230 to identify a caliper for paper of the primary roll 1. The characteristic determining apparatus 11 can employ a material analysis component 250 and profile creation component 260 to populate entries into the storage 230. The material analysis component 250 is configured to evaluate the refined paper of the secondary roll 3 to produce a secondary roll profile and to evaluate the paper of the primary roll 1 to produce a primary roll profile. The profile creation component 260 is configured to create an industrial process profile based, at least in part, on the secondary roll profile and the primary roll profile. This industrial process profile is configured for use in production of a subsequent primary roll to generate a subsequent secondary roll with a refined paper of a subsequent desired caliper. For example, the industrial process profile can be entered into the storage 230 as a database entry. Thus, the characteristic determining apparatus 11 and the database can learn as different refined papers are made.

The profile creation component 260 can be configured to check if an industrial roll profile related to the caliper or desired caliper exists in the database. If the industrial roll profile already exists, then the profile creation component 260 can check if the industrial roll profile is accurate. If the industrial roll profile is not accurate, then the industrial roll profile can be updated to be accurate. If the industrial roll profile does not already exist, then the industrial roll profile can be created. If the industrial roll profile already exists and is accurate, then the profile creation component 260 can stop operating.

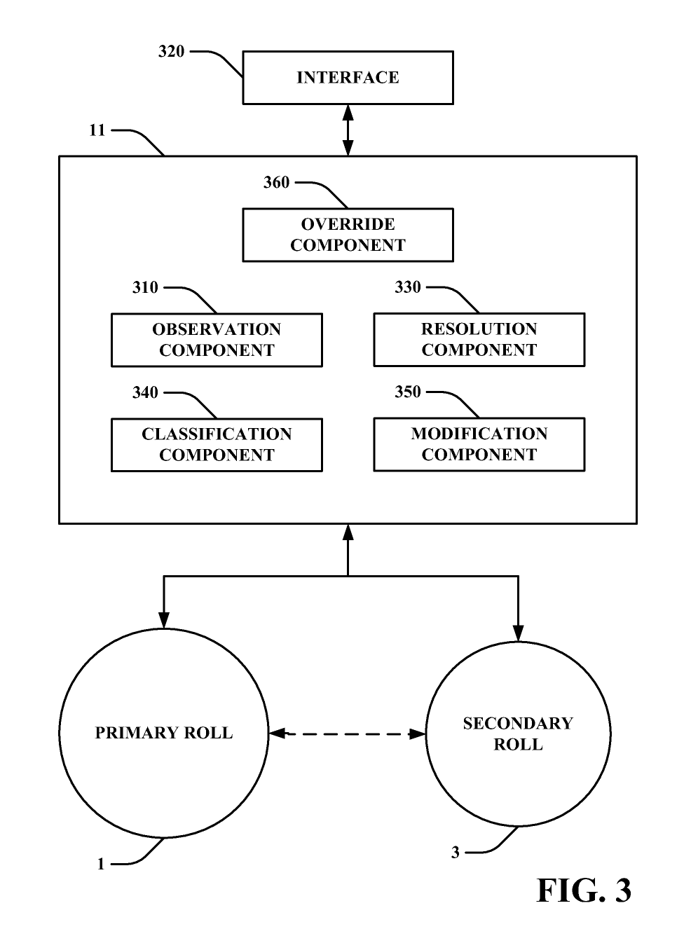

As shown in FIG. 3, the characteristic determining apparatus 11 additionally or alternatively includes an observation component 310, which is configured to monitor a property set of the secondary roll 3 and produce a monitoring signal indicative thereof.

The property set can be a default or user defined property set, e.g., designated by a technician through an interface 320. For instance, the technician can enter a desired caliper of the refined paper of the secondary roll 3 (e.g., an acceptable range of the desired caliper), a desired compressibility of the refined paper of the secondary roll 3, and others. Information entered by the technician can be formed into a criteria set.

The characteristic determining apparatus 11 also includes a resolution component 330 configured to make a determination on if the property set of the secondary roll meets a criteria set based, at least in part, on the monitoring result. Thus, the characteristic determining apparatus 11 can check quality of the refined paper of the secondary roll 3 without user interaction. In one embodiment, as opposed to using the resolution component 330, a technician can enter into the system 100 of FIG. 1 that the refined paper of the secondary roll 3 is not satisfactory.

A classification component 340 is configured to identify a change for a property set for the paper of the primary roll 1 (e.g., in response to the determination being that the property set of the refined paper of the secondary roll 3 does not meet the criteria set) and a modification component 350 makes the change.

In one embodiment, when the technician enters the criteria set, the characteristic determining apparatus 11 can determine that two potential property sets of the paper primary roll 1 can produce a refined paper of the secondary roll 3 with the desired qualities. For example, caliper of the paper of the primary roll 1 can be changed or moisture of the paper of the primary roll 1 can be changed; both these changes can produce the desired quality for the refined paper. Initially, the characteristic determining apparatus 11 can change the caliper of the paper of the primary roll 1. However, due to various factors the caliper change may not produce a desired caliper for the refined paper (e.g., a database entry is outdated). In response to this, the characteristic determining apparatus 11 can change the caliper of the paper of the primary roll 1 back and also change the moisture of the paper of the primary roll 1 such that the desired caliper of the refined paper is reached.

In one embodiment, a technician can enter a criteria set for the refined paper of the secondary roll 3. The system 100 of FIG. 1 can produce the secondary roll 3. However, the refined paper of the secondary roll may not meet the criteria set. However, the technician may determine that the refined paper is still of a high enough quality level. Thus, even though the criteria set is not met, the technician can employ an override component 360 to stop the process (e.g., override operation of the modification component 350).

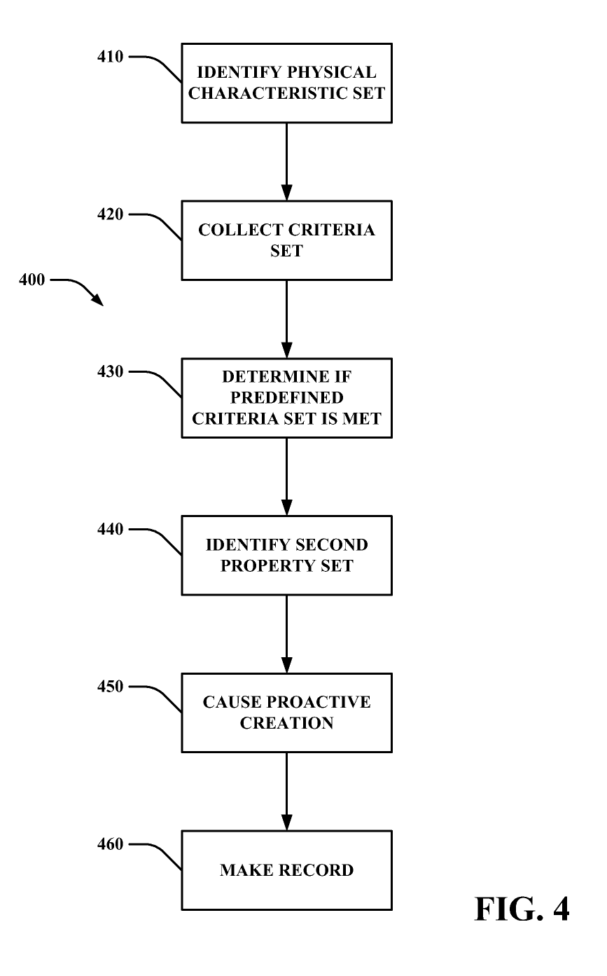

FIG. 4 illustrates one embodiment of a method 400 that can be employed in association with the system 100 of FIG. 1.

At 410, a physical characteristic set of a material of a first secondary roll is identified. In one example, the observation component 310 of FIG. 3 performs 410.

At 420, a predetermined criteria set is obtained or collected (e.g., from a technician).

At 430, a determination is made on if the physical characteristic set of the material of the first secondary roll meets a predefined criteria set. For example, at 430 a determination can be made on if the refined paper has a desirable moisture level. The determination can be represented via a signal, a value, and/or other indicia.

At 440, a second property set for a second primary roll occurs is identified. This can occur without user interaction and in response to determining that the physical characteristic set of the material of the first secondary roll does not meet the predefined criteria set. The second property set causes a physical characteristic set of a material of a second secondary roll to meet the predefined criteria.

At 450, the second primary roll is proactively created (e.g., without user interaction) with the second property set.

In one embodiment, while producing a second secondary roll, a measurement of the average caliper θs the primary roll 1 of FIG. 1 and the secondary roll 3 of FIG. 1 can be made. This can be done a roll's final diameter “D”, length “L” and core diameter “d” on which material is wound based on Equation 1:

θs=0.25*π*(D**2−d**2)/L. Equation 1

An average secondary rolls caliper “θs-avg” for a given primary roll rewound to “n” secondary rolls can be based on Equation 2:

$$θ s \cdot avg = ( {\sum }_{k = 1}^{n} θ sk * Lk ) / {\sum }_{i = 1}^{n} Li . \qquad Equation 2$$

A caliper compression function (CCF) can be created as a relation of the average caliper profiles of the primary roll 1 and secondary roll 3 based on Equation 3:

CCF(v)=θ_{s.avg}/θ_{p.avg} Equation 3

‘where “v” is a vector comprising but not limited to: material grade, average moisture, average basis weight and primary roll size.

At 460, an entry of primary roll production data can be made in the storage 230 as discussed in connection with FIG. 2. In one embodiment, the primary roll production data comprises final roll diameter, length, material grade, the average values for the basis weight, moisture, and caliper (e.g., θp-avg). The production data can also include profiles of basis weight, moisture, and caliper as a function of primary roll diameter, length, and material grade.

In addition, winding profiles and winding recipe can be part of the production history. Continuous compression profiles can be created and stored in the database as a relation of the caliper profiles between the primary roll 1 of FIG. 1 and the secondary roll 3 of FIG. 1 against the primary roll diameter and length (e.g., as part of the production history). The profiles can be classified according to the material grade and primary roll sizes.

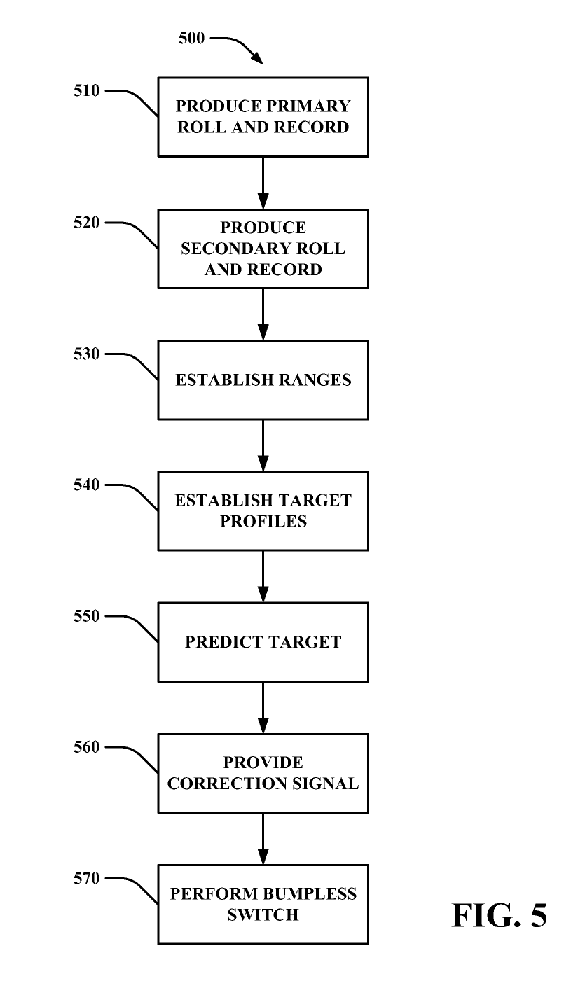

FIG. 5 illustrates one embodiment of a method 500 by which a caliper of the primary roll 1 of FIG. 1 and secondary roll 3 of FIG. 1 can be controlled to achieve a desired caliper of the refined paper secondary roll within an acceptable secondary roll structural quality.

The method 500 comprises, at 510, producing the primary roll 1 of FIG. 1 and recording into dedicated historical data storage as a function of wound material length roll diameter and the profiles of: paper caliper, moisture, basis weight, nip force and web tension.

At 520, the method 500 comprises producing the secondary roll 3 of FIG. 1 and recording into historical storage as a function of wound material length and diameter of the primary roll the profiles of: secondary roll paper caliper, nip force, winding force and web tension. In one embodiment, the profiles can be of torque, nip, and tension—which can be known as TNT parameters.

At 530, the method 500 comprises establishing (e.g., via standard quality tests and the analysis of the caliper profiles) ranges of the permitted variations of the TNT parameters allowing producing rolls of an acceptable quality and flat caliper profile depending on the secondary roll position within the primary roll and paper grade parameters.

At 540, the method comprises establishing target caliper compression profiles for mid range TNT control recipes. In one embodiment, caliper compression can be represented by a curve or single average parameter.

At 550, for a new primary rolls of grades that have already been produced and processed into the secondary rolls, using the most recent historical caliper compression curve to predict the caliper target to achieve desired caliper of the secondary rolls takes place.

At 560, providing correction signal to the basis weight and moisture control loops to influence the compressibility property of the material to limit resultant secondary roll caliper fluctuation occurs. In one embodiment, occurrence of 560 is optional and/or is dependent on an overall production strategy, knowing the secondary roll composition of the primary rolls being produced and an expected density gain (e.g., expressed as caliper compression) function.

At 570, bumpless switching occurs to an alternative TNT recipe to either reduce or increase average caliper of the secondary roll. In one embodiment, 570 occurs optionally while producing secondary rolls after a first on line validation of a resultant caliper, if the deviation from the target exceeds the pre-set threshold.

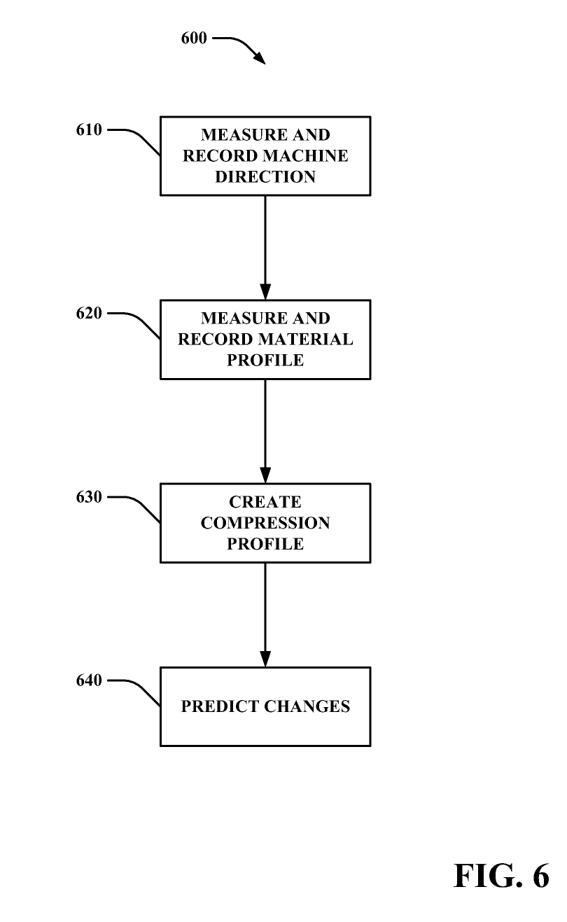

FIG. 6 illustrates one embodiment of a method 600 that includes change prediction.

The material can be supplied by a primary roll 1 of material of FIG. 1 and the system 100 of FIG. 1 can employ a method that include controlling caliper (or caliper) of the primary roll 1 of FIG. 1. Controlling the caliper of the primary roll 1 of FIG. 1 of material can be based on a measured caliper of the secondary roll 3 of FIG. 1 produced from a previously produced primary roll of the same or a similar material type. The method can be applied to production of various paper categories and grades, as well as to production of other materials.

In one embodiment, the method comprises, at 610, measuring and recording the machine direction caliper profile of material layers, moisture and basis weight as a function of the roll diameter and length. In one example, this is done while producing the primary roll 1 of FIG. 1 on a reeling device.

The method can also comprise, at 620, measuring and recording material caliper profile, nip and winding forces as a function of primary and secondary roll diameter and length. In one example, this is done while producing smaller secondary rolls from the primary roll 1 of FIG. 1.

The method can further comprise, at 630, creating compression profiles where results can be classified by the parameters related to material grade, roll sizes and winding programs.

The method can also comprise, at 640, using acquired compression profiles and their historical aspect(s) to predict (e.g., automatically) off-line and on-line changes to a manner primary and secondary rolls are controlled to achieve the optimum caliper control of the secondary rolls.

The method 600 can be used in predicting optimum control set points for the process of producing the primary roll 1 of FIG. 1 and secondary roll 3 of FIG. 1 to achieve a desired caliper of the refined paper of the secondary roll 3 of FIG. 1 based on the material profiles continuously measured during production of the primary roll 1 of FIG. 1 and secondary roll 3 of FIG. 1.

The above may be implemented by way of computer readable instructions, which when executed by a computer processor(s), cause the processor(s) to carry out the described techniques. In such a case, the instructions can be stored in a computer readable storage medium (e.g., non-signal computer readable store medium) associated with or otherwise accessible to the relevant computer.

As used herein, the term ‘component’ can refer to software, hardware, firmware, a controller, software in execution, or a combination thereof. In one example, a processor can function as a component. For example, with reference to FIG. 2, the calculation component 210 can function as one processor, as three separate processors, combined with another component disclosed herein on one processor, and other configurations. In another example, these components can be instruction sets retained on at least one computer-readable storage medium such as physical memory. Additionally or alternatively, at least one instruction set can be carried in other computer-readable medium (or non-computer-readable storage medium) such in a carrier wave or signal. The components can include the instruction sets and/or the computer-readable medium(s).

Of course, modifications and alterations will occur to others upon reading and understanding the preceding description. It is intended that the invention be construed as including all such modifications and alterations insofar as they come within the scope of the appended claims or the equivalents thereof.

What is claimed is:

1. A method of an industrial process that produces a primary roll of material and a secondary roll of the material, the method comprising:
identifying a physical characteristic set of a material of a first secondary roll of the material, where the material of the first secondary roll is produced from a material of a first primary roll and where the first primary roll is produced with a first property set;
determining if the physical characteristic set of the material of the first secondary roll meets a predefined criteria set;
identifying, in response to determining that the physical characteristic set of the material of the first secondary roll does not meet the predefined criteria set, a second property set for a second primary roll, where the second property set and the first property set are different and where the second property set causes a physical characteristic set of a material of a second secondary roll to meet the predefined criteria; and
causing without user interaction, the second primary roll to be proactively created with the second property set.

2. The method of claim 1, where the predefined criteria set includes a caliper value.

3. The method of claim 2, where the first primary roll, the second primary roll, the first secondary roll and the second secondary roll are rolls of a paper.

4. The method of claim 3, comprising:
making an entry into a historical record, where the entry includes the first property set and the physical characteristic set of the material of the first secondary roll.

5. The method of claim 3, where the predefined criteria set includes, in addition to the caliper value, at least one of: moisture, basis weight, nip force, caliper fluctuation, or web tension.

6. The method of claim 1, where identifying a second property set for a second primary roll occurs without user interaction.

7. The method of claim 1, comprising:
collecting the predefined criteria set, where the criteria set is collected from a user interface.

8. A system, comprising:
a caliper determination component configured to proactively identify a caliper for material of a primary roll based, at least in part, on a desired caliper for a material of a secondary roll, where the secondary roll is produced from the primary roll; and
a controller configured to proactively cause the material of the primary roll to be produced with the caliper in response to identifying the caliper for the material of the primary roll.

9. The system of claim 8, comprising:
a secondary roll check component configured to make a determination on if the material of the secondary roll is being produced with the desired caliper, where the caliper determination component operates in response to the determination being that the material of the secondary roll is not being produced with the desired caliper.

10. The system of claim 8, where the material of the primary roll is a paper material and where the material of the secondary roll is a paper material.

11. The system of claim 8, where a database includes a database entry, where the database entry includes information on what caliper for the material of the primary roll causes the material of the secondary roll to have the desired caliper, and where the calculation component finds the caliper for the material of the primary roll by searching the database for the database entry.

12. The system of claim 11, where the database entry is a most recent entry associated with the desired caliper.

13. The system of claim 8, comprising:
a material analysis component configured to evaluate the material of the secondary roll to produce a secondary roll profile and to evaluate the material of the primary roll to produce a primary roll profile; and
an profile creation component configured to create an industrial process profile based, at least in part, on the secondary roll profile and the primary roll profile, where the industrial process profile is configured for use in production of a subsequent primary roll to generate a subsequent secondary roll with a material of a subsequent desired caliper.

14. The system of claim 13, where the profile creation component is configured to check if an industrial roll profile related to the caliper or desired caliper exists in the database.

15. A system, comprising:
an observation component configured to monitor a property set of a material of a secondary roll from an industrial process to produce a monitoring result, where the property set of the material of the secondary roll includes caliper of the material of the secondary roll;
a resolution component configured to make a determination on if the property set of the material of the secondary roll meets a criteria set based, at least in part, on the monitoring result;
a classification component configured to identify, in response to the determination being that the property set of the material of the secondary roll does not meet the criteria set, a change for a property set of a material of the primary roll of the industrial process, where the material of the primary roll supplies the material of the secondary roll; and
a modification component configured to proactively alter the property set of the material of the primary roll with the change.

16. The system of claim 15, where the secondary roll is a paper roll, where the primary roll is a paper roll, and where proactive alteration of the property set of the primary roll with the change comprises at least one of:
proactive alteration of a basis weight associated with the primary roll;
proactive alteration of moisture associated with the primary roll; or
proactive alteration of calendaring associated with the primary roll.

17. The system of claim 15, where the secondary roll is a paper roll, where the primary roll is a paper roll, and where the property set includes, in addition to the caliper of the secondary roll, the individual properties of: secondary roll nip force; secondary roll winding force; and secondary roll web tension.

18. The system of claim 17, where the criteria set comprises acceptable ranges for the individual properties and the caliper of the secondary roll.

19. The system of claim 15, where the change is a preset alternative configuration associated with production of the primary roll.

20. The system of claim 15, comprising:
an override component configured to facilitate manual override of the modification component.
